(19) United States
(12) Patent Application Publication
(10) Pub. No.: US 2024/0286196 A1
(43) Pub. Date: Aug. 29, 2024

(54) PROCESS AND DEVICE FOR ADDITIVELY MANUFACTURING AT LEAST ONE COMPONENT THAT CAN BE EASILY DETACHED FROM A CARRIER

(71) Applicant: TRUMPF Laser- und Systemtechnik GmbH, Ditzingen (DE)

(72) Inventors: Youssef Gouddi, Korntal- Muenchingen (DE); Alex Esin, Sachsenheim (DE)

(21) Appl. No.: 18/660,286

(22) Filed: May 10, 2024

Related U.S. Application Data
(63) Continuation of application No. PCT/EP2022/080648, filed on Nov. 3, 2022.

(30) Foreign Application Priority Data
Nov. 12, 2021 (DE) 10 2021 129 549.1

(51) Int. Cl. B22F 10/40; B22F 10/28; B33Y 10/00; B33Y 30/00

(52) U.S. Cl. CPC B22F 10/40; B22F 10/28; B33Y 10/00; B33Y 30/00

(57) ABSTRACT

A production process includes heating a carrier to above 400° C., and additively manufacturing a first support structure on the heated carrier by laser melting a metal powder. The first support structure has multiple first support struts. A length of the first support struts is greater than a maximum width of the first support struts. The production process further includes additively manufacturing a first component on the first support structure by laser melting the metal powder, and detaching the first component from the first support structure.

### CROSS REFERENCE TO RELATED APPLICATIONS

This application is a continuation of International Application No. PCT/EP2022/080648 (WO 2023/083682 A1), filed on Nov. 3, 2022, and claims benefit to German Patent Application No. DE 10 2021 129 549.1, filed on Nov. 12, 2021. The aforementioned applications are hereby incorporated by reference herein.

### FIELD

Embodiments of the present invention relate to a production process for additively manufacturing at least one component, and to a production device for additively manufacturing at least one component.

### BACKGROUND

It is known to use additive manufacturing processes in order to be able to produce components flexibly. Such a manufacturing process has been disclosed, for example, in EP 1 355 760 B1.

A problem with the known manufacturing process is that deformation (“distortion”) of the component often occurs during the manufacturing. This can be counteracted by connecting the component to a carrier over a large surface area. In this case, however, the finished component can no longer be non-destructively detached from the carrier.

### SUMMARY

Embodiments of the present invention provide a production process. The production process includes heating a carrier to above 400° C., and additively manufacturing a first support structure on the heated carrier by laser melting a metal powder. The first support structure has multiple first support struts. A length of the first support struts is greater than a maximum width of the first support struts. The production process further includes additively manufacturing a first component on the first support structure by laser melting the metal powder, and detaching the first component from the first support structure.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows an isometric view of a carrier and a first component on the carrier, the first component being supported on the carrier via a first support structure, according to some embodiments.

FIG. 2 shows an isometric bottom view of the first component in FIG. 1, according to some embodiments.

FIG. 3 shows multiple components manufactured one on top of another, according to some embodiments.

FIG. 4a shows a multiplicity of components manufactured one on top of another and supported on a carrier via support and carrying structures, according to some embodiments.

FIG. 4b shows the removal of some of the components in FIG. 4a, according to some embodiments.

FIG. 4c shows the carrying structures remaining after all the components in FIG. 4b have been removed, according to some embodiments.

### DETAILED DESCRIPTION

Embodiments of the invention provide a process and a device for producing at least one component, which enable the dimensionally stable manufacture of the at least one component, it still being possible for the at least one component to be easily detached from a carrier.

According to embodiments of the invention, a production process comprising the following process steps:
A) heating a carrier to more than 400° C.;
B) additively producing a first support structure on the heated carrier, the production being effected by laser melting a metal powder, the first support structure having multiple first support struts, the length of the first support struts exceeding their width;
C) additively producing a first component on the first support structure by laser melting a metal powder;
J) separating the first component from the first support structure.

As a result of the combination of heated carrier and filigree first support struts between the carrier and the first component, the first component is manufactured with low stress and without distortion and can still be easily detached from the carrier.

In process step A), the carrier is heated preferably to above 450° C., in particular to above 500° C. The elevated temperature is maintained while the subsequent process steps are being carried out.

The filigree first support struts are narrow, in particular rod-like, with the maximum width being understood to mean the outer size of the respective first support strut at its widest point. As an alternative or in addition to this, the first support struts may each have one or more branches, in order to form in particular a respective tree structure. The first support struts may each be in the form of a tree limb with at least one branch and/or in the form of a fragmented line.

With particular preference, multiple first support struts, in particular all the first support struts, have the same form.

The metal powder used is preferably a titanium alloy, in particular a titanium-aluminium-vanadium alloy, preferably a Ti₆Al₄V alloy, or pure titanium, in particular CP Ti grade 1, 2, 3 or 4.

The first support structure and the first component are preferably manufactured in the powder bed.

To produce the first support structure, use is preferably made of the same metal powder as was used to produce the first component. This makes it possible to further reduce stresses.

The carrier is preferably in the form of a plate.

In a preferred embodiment, the connections between the first component and the first support structure are severed by a movement of the first component relative to the first support structure.

A tool attachment, for example a polygon, may be manufactured on the first component.

A tool, in particular a rotary tool, for example a wrench, can be used to move the first component. The tool may engage with the tool attachment.

However, the connections between the first component and the first support structure are preferably severed without tools, in particular without applying a cutting tool to the connections. In other words, it is possible for the connections to be broken off, but not cut through.

The first support struts may have a respective intended breaking point at their point of attachment to the first component. This makes it possible to detach the first component even more easily.

The first support struts may take up less than 70% of the volume delimited by the first support structure. The first support struts preferably take up less than 50%, in particular less than 30%, of the volume delimited by the first support structure.

The maximum attachment surface of the first support structure is preferably less than 3% of the total projected support surface.

The maximum volume of the supports is preferably less than 3% of the volume spanned between the support surface and its projection onto the carrier.

The length of the first support struts preferably corresponds to more than 4 times the maximum width of the first support struts. The length of the first support struts preferably corresponds to more than 6 times, preferably more than 8 times, preferably more than 10 times, the maximum width of the first support struts.

The first support struts may extend axially at least in certain portions and radially at least in certain portions between the carrier and the first component. The axial direction is understood to mean the direct axis of connection between the carrier and the first component. The radial direction is understood to mean a direction perpendicular to the axial direction and towards the centre of the first component. As a result, the first component can be detached by a rotary movement easily.

The first support struts may have a contour without a filling. In this case, the laser beam is moved only along the contour of the first support struts and not inside the first support struts. As an alternative to this, the first support struts may have only a filling without a contour, in particular in the form of a hatched filling. In this case, the laser beam is moved only inside the first support struts. The first support struts may be detached easily in the aforementioned cases.

The first component may be in the form of a hemispherical shell. The first component is preferably in the form of a hip joint socket.

The production process may comprise the following further process steps:
D) additively manufacturing a carrying structure on the carrier by laser melting a metal powder;
E) additively manufacturing a second support structure with second support struts on the carrying structure by laser melting a metal powder;
F) additively manufacturing a second component on the second support structure by laser melting a metal powder, the second component not having any direct contact with the first component or with the carrying structure.

Process steps D) to F) make it possible to additively manufacture two components one on top of the other.

The second component may be detached from the second support structure before, after or at the same time as process step J). The connections between the second component and the second support structure are preferably severed without tools by a movement of the second component relative to the second support structure. A tool, for example a wrench, can be used to move the second component. However, the connections between the second component and the second support structure are preferably severed without tools, in particular without applying a cutting tool.

The metal powder used in process steps D) to F) preferably corresponds to the metal powder used in process steps B) and C). Process steps D) to F) may be carried out in the powder bed.

The carrying structure is preferably more bulky and/or more solid than the second support structure.

The second support structure may have one or more of the features described above with regard to the first support structure. In particular, the first support structure and the second support structure may have the same form.

The production process may comprise the following additional process steps:
G) additively manufacturing a further carrying structure on the carrying structure by laser melting a metal powder;
H) additively manufacturing a further support structure with further support struts on the further carrying structure by laser melting a metal powder;
I) additively manufacturing a further component on the further support structure by laser melting a metal powder, the further component not having any direct contact with the second component or with the further carrying structure.

The further component may be detached from the further support structure before, after or at the same time as process step J). The connections between the further component and the further support structure are preferably severed without tools by a movement of the further component relative to the further support structure. A tool, for example a wrench, can be used to move the further component. However, the connections between the further component and the further support structure are preferably severed without tools, in particular without applying a cutting tool.

The metal powder used in process steps G) to I) preferably corresponds to the metal powder used in process steps B) and C). Process steps G) to I) may be carried out in the powder bed.

The further carrying structure is preferably more bulky and/or more solid than the further support structure.

The further support structure may have one or more of the features described above with regard to the first support structure. In particular, the further support structure and the second support structure may have the same form.

Process steps G) to I) may expediently be repeated once or multiple times, in order to additively manufacture further components on top of one another.

When carrying out the process according to embodiments of the invention, preferably all the structures, for example support structures, components and carrying structures, that are in a plane are exposed plane by plane.

Multiple components, in particular all the components, preferably have the same form. As an alternative or in addition to this, multiple carrying structures, in particular all the carrying structures, may have the same form.

According to embodiments of the invention, a production device, in particular for carrying out a process described here, having the following features:
a) a carrier heated to more than 400° C.;
b) a first support structure additively produced on the heated carrier by laser melting a metal powder, the first support structure having multiple first support struts, the first support struts being longer than they are wide;
c) a first component additively produced on the first support structure by laser melting a metal powder.

The connections between the first support structure and the first component may be severable, preferably without tools, by a movement of the first component relative to the first support structure. It may in particular be possible to break off the connections.

The first component may have a tool attachment, for example a polygon. The tool attachment makes it easier to move the first component relative to the first support structure, in order to break the connections. A tool, in particular a rotary tool, for example a wrench, may be provided to move the first component relative to the first support structure.

The production device may also have the following features:
d) a carrying structure additively produced on the carrier by laser melting a metal powder;
e) a second support structure which is additively produced on the carrying structure by laser melting a metal powder and has second support struts;
f) a second component additively produced by laser melting a metal powder, the second component not having any direct contact with the first component or with the carrying structure.

The production device may also have the following features:
g) a further carrying structure additively produced on the carrying structure by laser melting a metal powder;
h) a further support structure which is additively manufactured on the further carrying structure by laser melting a metal powder and has further support struts;
i) a further component produced by laser melting a metal powder, the further component not having any direct contact with the second component or with the further carrying structure.

One or more of the features described with regard to the process can correspondingly be provided on the production device.

Further advantages of the embodiments of the invention emerge from the description and the drawing. Similarly, the features mentioned above and the features still to be explained may each be used on their own or together in any desired combinations according to embodiments of the invention. The embodiments shown and described should not be understood as an exhaustive list, but rather as being of an exemplary character for the description of the invention.

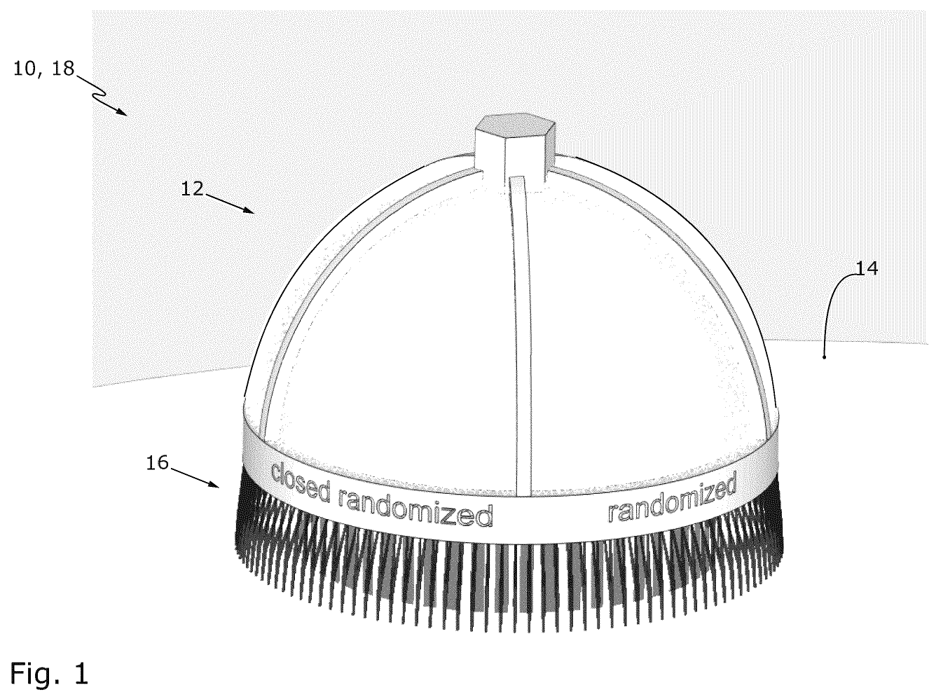

FIG. 1 shows a production device 10 for manufacturing a first component 12, in this instance in the form of a hip joint socket. The production device comprises a heated carrier 14. The first component 12 is supported on the carrier 14 via a first support structure 16.

The first component 12 is produced by a production process 18 according to embodiments of the invention. During this production process 18, the carrier 14 is heated to above 400° C. and the first component 12 is manufactured by at least one laser beam (not shown), which melts a metal powder in the powder bed (not shown). The high temperature of the carrier 14 makes it possible to manufacture the first component 12 with low stress. As a result, it is sufficient to attach the component 12 to the carrier 14 merely by way of the very filigree first support structure 16. The filigree design of the first support structure 16 in turn makes it possible to easily separate the first component 12 from the first support structure 16.

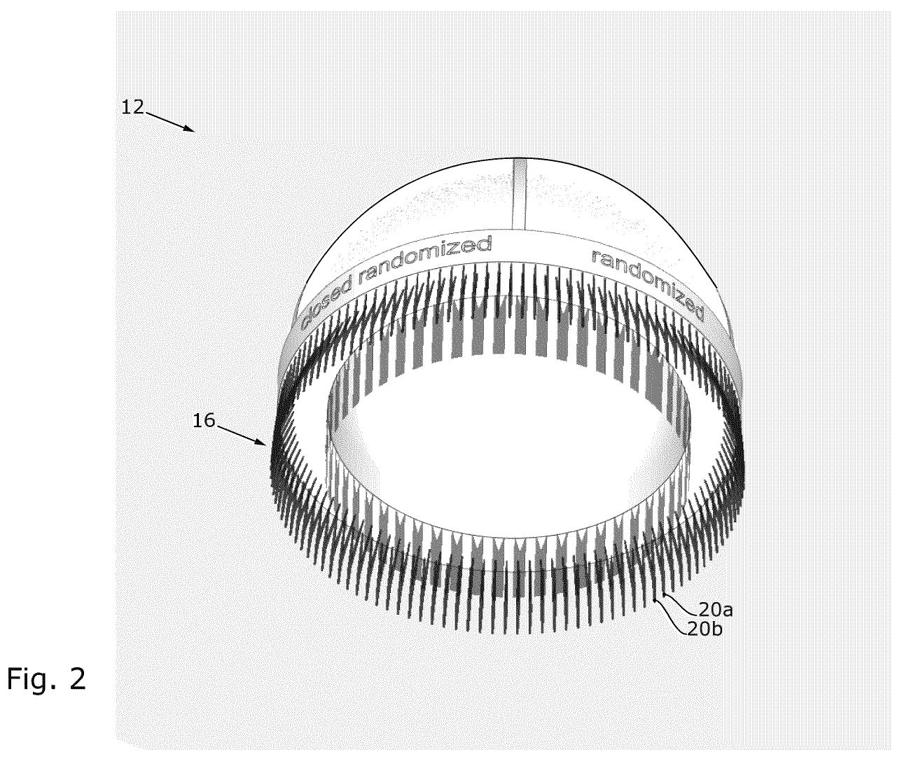

FIG. 2 shows the first component 12 and the first support structure 16. It is clear from FIG. 2 that the first support structure has a multiplicity of first support struts, only two first support struts 20a, 20b of which are provided with a reference sign in FIG. 2 for the sake of clarity.

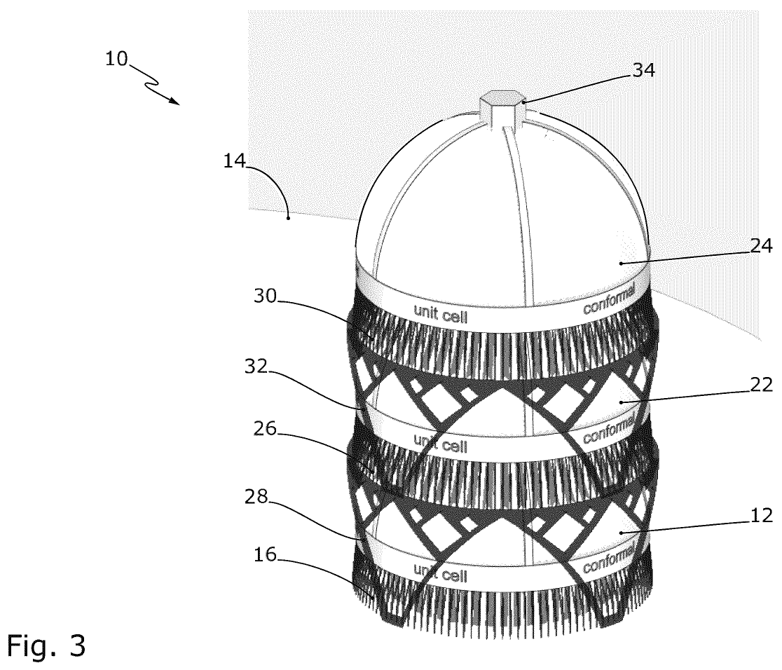

FIG. 3 shows the production device 10, it being clear from FIG. 3 that a second component 22 and a further component 24 are manufactured in addition to the first component 12. The second component 22 is supported on a carrying structure 28, which in turn rests on the carrier 14, via a second support structure 26. The further component 24 is supported on a further carrying structure 32, which is connected to the carrying structure 28, via a further support structure 30. The components 12, 22, 24 are thus each supported on carrying structures 28, 32 or on the carrier 14 via support structures 16, 26, 30. As a result, multiple components 12, 22, 24 can be indirectly cohesively manufactured with low stress and still be removed easily. For easy detachment, at least one component 12, 22, 24 may have a tool attachment 34, in this instance in the form of a polygon.

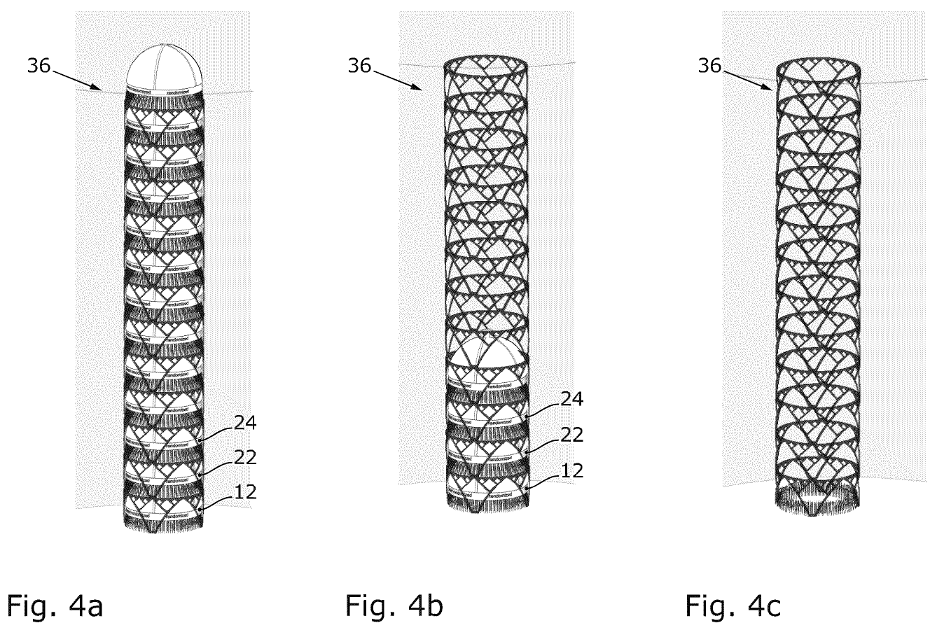

FIGS. 4a-c show the removal of multiple components from a framework 36 of carrying and support structures, with only the components 12, 22, 24 already shown in FIG. 3 being provided with a reference sign for the sake of clarity. It is clear from FIGS. 4a-c that the components 12, 22, 24 can be completely removed from the frame 36.

As described above, embodiments of the invention relate to a production process 18 for producing a first component 12 by additive laser manufacture from metal powder. The first component 12 is connected to a carrier 14, which is heated to more than 400° C., via a first support structure 16. The first support structure 16 may have a multiplicity of first support struts 20a, b which have a filigree form, with the result that the first component 12 can be easily separated from the first support structure 16. In addition to this, a carrying structure 28 may be deposited on the carrier 14, a second component 22 being supported on the carrying structure 28 via a second support structure 26. A further carrying structure 32, which supports a further component 24 via a further support structure 30, may be formed on the carrying structure 28. Embodiments of the invention also relate to a production device 10, in particular for carrying out the production process 18.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

10 Production device
12 First component
14 Carrier
16 First support structure
18 Production process
20a, b First support struts
22 Second component
24 Further component
26 Second support structure
28 carrying structure
30 Further support structure
32 Further carrying structure
34 Tool attachment
36 Framework

1. A production process comprising:
heating a carrier to above 400° C.;
additively manufacturing a first support structure on the heated carrier by laser melting a metal powder, the first support structure having multiple first support struts, and a length of the first support struts being greater than a maximum width of the first support struts;
additively manufacturing a first component on the first support structure by laser melting the metal powder; and
detaching the first component from the first support structure.

2. The production process according to claim 1, wherein the detaching the first component from the first support structure comprises severing connections between the first component and the first support structure, without tools, by a movement of the first component relative to the first support structure.

3. The production process according to claim 2, wherein a rotary tool, which engages with a tool attachment of the first component, is used to move the first component relative to the first support structure.

4. The production process according to claim 1, wherein each respective first support strut has a respective intended breaking point between the respective first support strut and the first component.

5. The production process according to claim 1, wherein the first support struts take up less than 70% of a volume delimited by the first support structure.

6. The production process according to claim 1, wherein the length of the first support struts corresponds to more than 4 times the maximum width of the first support struts.

7. The production process according to claim 1, wherein the first support struts extend axially at least in certain portions and radially at least in certain portions between the carrier and the first component.

8. The production process according to claim 1, wherein the first support struts have a contour without a filling.

9. The production process according to claim 1, wherein the first component is in a form of a hemispherical shell.

10. The production process according to claim 1, further comprising, before the detaching the first component from the first support structure:
additively manufacturing a carrying structure on the carrier by laser melting the metal powder;
additively manufacturing a second support structure with second support struts on the carrying structure by laser melting the metal powder; and
additively manufacturing a second component on the second support structure by laser melting the metal powder, the second component not having any direct contact with the first component or any direct contact with the carrying structure.

11. The production process according to claim 10, further comprising, before the detaching the first component from the first support structure:
additively manufacturing a further carrying structure on the carrying structure by laser melting the metal powder;
additively manufacturing a further support structure with further support struts on the further carrying structure by laser melting the metal powder; and
additively manufacturing a further component on the further support structure by laser melting the metal powder, the further component not having any direct contact with the second component or any direct contact with the further carrying structure.

12. A production device, comprising:
a carrier heated to above 400° C.;
a first support structure additively manufactured on the heated carrier by laser melting a metal powder, the first support structure having multiple first support struts, and a length of the first support struts being greater than a maximum width of the first support struts; and
a first component additively manufactured on the first support structure by laser melting the metal powder.

13. The production device according to claim 12, wherein connections between the first support structure and the first component can be severed, without tools, by a movement of the first component relative to the first support structure.

14. The production device according to claim 12, wherein the first component comprises a tool attachment.

15. The production device according to claim 12, further comprising:
a carrying structure additively manufactured on the carrier by laser melting the metal powder;
a second support structure additively manufactured on the carrying structure by laser melting the metal powder and has second support struts; and
a second component additively manufactured by laser melting the metal powder, the second component not having any direct contact with the first component or any direct contact with the carrying structure.

16. The production device according to claim 15, further comprising:
a further carrying structure additively manufactured on the carrying structure by laser melting the metal powder;
a further support structure additively manufactured on the further carrying structure by laser melting the metal powder and has further support struts; and
a further component additively manufactured by laser melting the metal powder, the further component not having any direct contact with the second component or any direct contact with the further carrying structure.
